(19) United States
(12) Patent Application Publication
(10) Pub. No.: US 2002/0082911 A1
(43) Pub. Date: Jun. 27, 2002

(54) Online revenue sharing

(76) Inventors: Charles L. Dunn, Lauderhill, FL (US); Blair Todd Germano, Pembroke Pines, FL (US)

Correspondence Address: KIRKPATRICK & LOCKHART LLP, 75 STATE STREET, BOSTON, MA, 02109-1808, US

(21) Appl. No.: 09/745,769

(22) Filed: Dec. 22, 2000

(51) Int. Cl. G06F 17/60

(52) U.S. Cl. 705/14; 705/39

(57) ABSTRACT

Online billing includes determining if a third party referred an online buyer of a good not requiring physical delivery to an online seller of the good not requiring physical delivery and apportioning revenue from sale of the good not requiring physical delivery between the online seller and, if a third party referred the online buyer to the online seller, to the third party.

### BACKGROUND

This invention relates to online billing.

Many sales made over a public network such as the Internet involve items that are intangible. A purchaser of an intangible item may obtain what he or she is seeking through online fulfillment because no tangible, physical product needs to be shipped or delivered to the purchaser. Intangible items may be purchased on a one-time basis. In other cases, intangible items may be purchased through a subscription in which the purchaser is automatically rebilled on a recurring basis to maintain ongoing access to the intangible items, with the purchaser reserving the option to cancel the access at a subsequent time.

### SUMMARY

According to one aspect of the present invention, online billing includes determining if a third party referred an online buyer of a good not requiring physical delivery to an online seller of the good not requiring physical delivery and apportioning revenue from sale of the good not requiring physical delivery between the online seller and, if a third party referred the online buyer to the online seller, to the third party.

According to another aspect of the present invention, a system includes a first mechanism configured to connect to a public network and to enable a buyer to purchase a good not requiring physical delivery over the public network from a seller and a second mechanism configured to connect to the public network, to confirm payment for the good not requiring physical delivery before the good not requiring physical delivery is delivered to the buyer, and to apportion the payment between the seller and a third party that referred the buyer to the seller via the public network.

According to another aspect of the present invention, online billing includes registering an online seller of a good with an entity and registering a third party with the entity as eligible to receive a portion of revenues from sales of the good sold by the online seller to an online buyer who navigated across a network to the online seller via the third party. It is automatically determined if the third party referred the online buyer of the good to the online seller of the good and revenue is automatically apportioned from sale of the good between the online seller and, if a third party referred the online buyer to the online seller, to the third party according to a predetermined payment structure. It is automatically determined if a fourth party referred the third party to the online seller and if so, revenue is automatically apportioned from the sale of the good between the online seller and, if the third party referred the online buyer to the online seller, to the third party and to the fourth party according to a predetermined payment structure. Data is automatically provided online regarding the sale of the good to the online seller, to the third party if the third party referred the online buyer to the online seller, and the fourth party if the fourth party referred the third party to the online seller.

One or more of the following advantages may be provided by one or more aspects of the invention.

The invention provides a simple, efficient way to split revenues for intangible items purchased online. Moreover, the revenues split between the various entities involved in the online purchase may be recorded and accounted for automatically, whether the intangible items are purchased on a one-time basis or on a subscription basis.

Because the revenue splits can be accurately and automatically tracked for any number of online merchants, the invention can provide a commission tracking program as well as a system to distribute funds owed from the revenue splits for each of the online merchants. The invention provides real-time online statistics regarding an online merchant's sales. In this way, the online merchants can manage their sales activity through the invention without having to perform their own bookkeeping.

For example, online merchants who sell intangible items (or otherwise accept money for intangible items such as taking charitable donations) can view statistics surrounding their sales. An online merchant's statistics can include number of initial sales, how many rebillings resulted from the number of initial signups, and who referred buyers to the online merchant, e.g., revenue sharers who receive a percentage of the online merchant's revenues for sales resulting from referrals of buyers to the online merchant's web site. In this way, the online merchants can track sales patterns, track revenues, and verify that they will receive the correct portion of the revenue split of their net sales. Similarly, a revenue sharer can track revenues earned by the online merchant resulting from its own referral of buyers to the online merchant and verify that the revenue sharer will receive the correct portion of the revenue split of the online merchant's net sales.

By the merchant sharing a percentage of their net sales with revenue sharers, revenue sharers have an incentive to refer customers and other revenue sharers to the online merchants. This helps the online merchants build a network including an unlimited number of advertisers, getting more and more referred business from the revenue sharers. At the same time, the online merchants can reduce their own advertising ventures and expenses. Furthermore, through the use of multiple master accounts and sub-accounts, an online merchant can set different percentage revenue splits for different ones of its revenue sharers and for each of its various web sites that sell intangible items.

The invention also provides a simple, efficient way for a web site to track ongoing referrals and multi-tiered commission payouts to entities that refer end users to the web site, whether or not the end users purchase any tangible or intangible goods or services from the web site. In such a case, the web site may offer a flat fee for every end user that an entity refers to the web site.

Other advantages and features will become apparent from the following description and from the claims.

### DESCRIPTION OF DRAWINGS

FIG. 1 is a block diagram of a network configuration.

FIGS. 2A-2C illustrate examples of revenue splits.

FIG. 3 is a flowchart of a revenue sharing process.

FIG. 4 is a flowchart of a revenue sharing registration process.

FIG. 5 is a block diagram showing an example of a revenue sharing hierarchy.

FIG. 6 shows a merchant login screen.

FIG. 7 shows a merchant menu screen.

FIGS. 8-12 show merchant setup screens.

FIGS. 13-17 show merchant accounting screens.

FIG. 18 shows a projection report screen.

FIG. 19 shows a revenue sharer menu screen.

FIGS. 20-22 show revenue sharer accounting screens.

FIG. 23 shows a revenue sharer setup screen.

### DETAILED DESCRIPTION

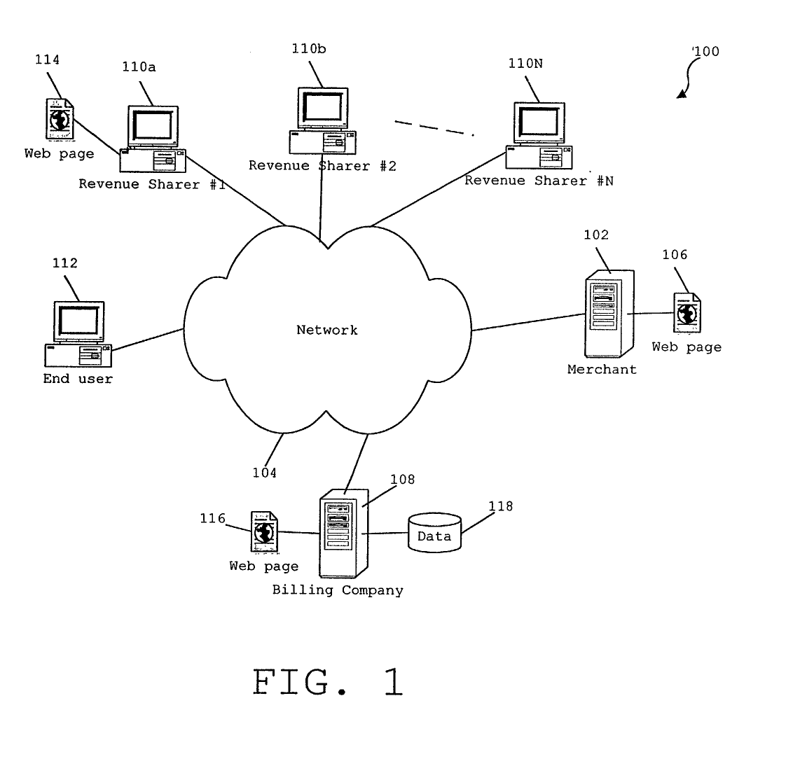

Referring to FIG. 1, a network configuration 100 includes a merchant 102 that provides a web page 106 offering intangible goods for purchase over a public network 104 such as the Internet. Examples of intangible goods (including intangible services) include donations, access to online data searches, access to members-only Internet web pages, clip-art files, text files, documents, pictures, educational/training materials, entertainment software, technical information, game software, stock-picks, horoscopes, biorhythms, psychic readings, patent searches, marketing data, music files, photographs, artwork, live or prerecorded media events, live or prerecorded sporting events, live or prerecorded streaming video or animations, meetings, conferences, distance-learning, speeches, and other similar items.

A billing company 108 provides the merchant 102 with an automated system that tracks sales of the merchant's intangible goods so that commission payouts can be made to a revenue sharer 110. The billing company 108 may also similarly track sales of any tangible goods offered by the merchant 102. A revenue sharer 110 is an individual, a company, or other entity that refers a potential buyer, e.g., an end user 112, to the merchant's web page 106 via, for example, its own web page 114. The merchant 102 and the billing company 108 may be individuals, companies, or other entities and are represented here as servers, although any mechanism can be used to support their respective web pages 106 and 116. Similarly, the revenue sharers 110 and the end user 112 may be individuals, companies, or other entities and are shown here as individual desktop or mobile computer workstations, although they can be any device capable of communicating with the public network 104 such as personal digital assistants, telephones, pagers, and other similar devices.

The billing company 108 may maintain or otherwise have access to a collection of data 118 (e.g., a database) used to help the billing company 108 detect and track fraudulent and otherwise undesirable activity. Examples of such activity are providing false information to the billing company 108, manipulating end user purchases, experiencing a high rate of refunds/chargebacks, maintaining a negative account balance, proven fraud, suspected fraud, and other similar activities. If a merchant or a revenue sharer engages in fraudulent or undesirable activity, the billing company 108 can cancel the appropriate party's registration with the billing company 108 and/or record the cancelled registration in the collection of data 118. Thus, the billing company 108 can, for example, retrieve and provide data to the merchant 102 explaining why the registration of one of its revenue sharers 110 was denied or cancelled. The collection of data 118 may also be used to store innocuous account information for the billing company's associated merchants and revenue sharers, including contact information, billing information, and account status.

The merchant 102 can have an unlimited number of revenue sharers 110; only one revenue sharer 110, revenue sharer 110a is discussed here for simplicity. Similarly, the billing company 108 can track sales for any number of merchants and revenue sharers; one merchant and one revenue sharer are discussed here for simplicity.

The merchant 102, the revenue sharer 110a, and the billing company 108 split net sales of the merchant's intangible goods to buyers (end users) referred to the merchant's web page 106 by the revenue sharer 110a based on predetermined percentages and transactions. The percentage amount split between the revenue sharer 110a and all other parties (e.g., the merchant 102, the billing company 108, and other revenue sharers 110) is typically an integer percentage between zero percent and seventy percent. At least thirty percent of the revenue is reserved for the merchant 102 so that the merchant 102 maintains an adequate amount of funds in its account to cover refunds, chargebacks, and other adjustments. Different merchants can have different percentage amount splits, and a single merchant may have different percentage amount splits for different revenue sharers. The merchant 102 may also be able to set percentages on a sliding scale so that payout percentages increase for those revenue sharers that send certain percentages or numbers of referrals to the merchant 102. The billing company 108 calculates the merchant's net sales by taking the merchant's gross sales and subtracting charges such as costs, fees, chargebacks, revokes, and refunds.

The billing company 108 pays the merchant 102, typically on a regular schedule such as weekly or bi-weekly. Service preferences of the billing company 108 or the merchant 102 may defer regularly scheduled payments until the payment reaches a certain minimum amount.

The billing company 108, the merchant 102, or both can pay the revenue sharers per service choices of the billing company 108 and/or the merchant 102. The billing company 108 may be able to pay the revenue sharer 110a directly from an account that the merchant 102 maintains with the billing company 108 or another party. If paid by the billing company 108, the revenue sharer 110a is also typically paid on a regular schedule, such as weekly or bi-weekly. Service preferences of the billing company 108, the merchant 102, or the revenue sharer 110a may defer regularly scheduled payments until the payment reaches a certain minimum amount. Furthermore, the billing company 108 may pay the revenue sharer 110a via separate payment methods (e.g., separate checks) for each merchant associated with the revenue sharer 110a or via one lump sum payment for all merchants.

The revenue sharer's status affects whether and when they receive payment. An active revenue sharer receives payment as scheduled. Payment owed to a suspended revenue sharer is held for the revenue sharer until its status is changed to active, in which case payment is made to the revenue sharer, or changed to deleted, in which case the merchant can receive the payment owed to the revenue sharer.

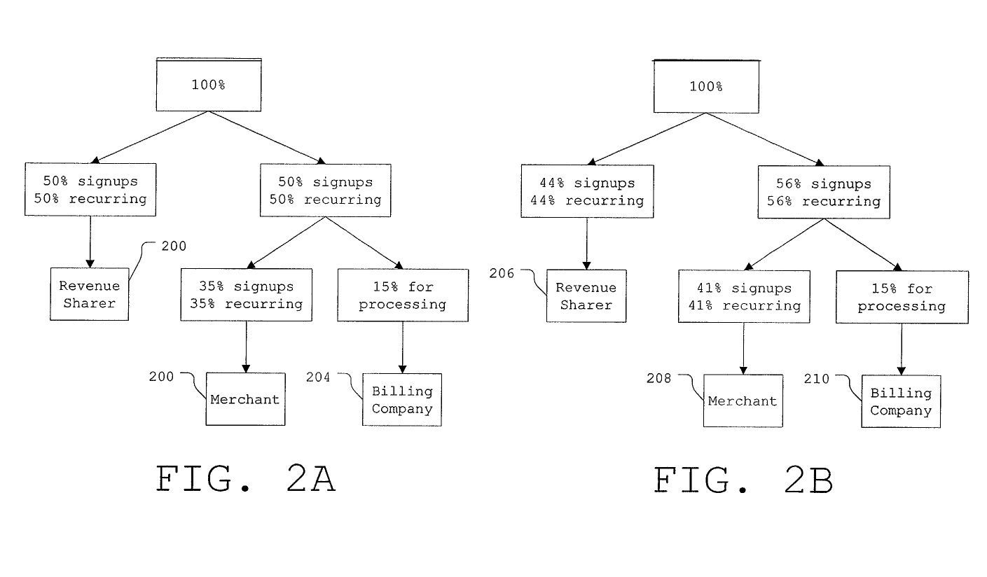

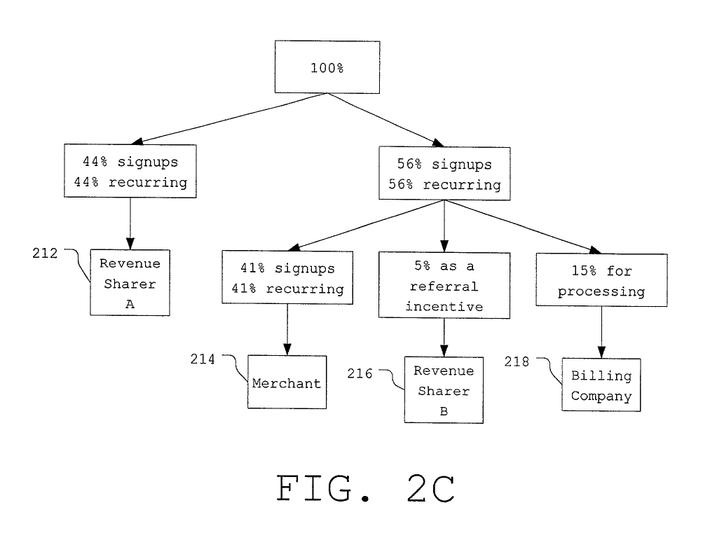

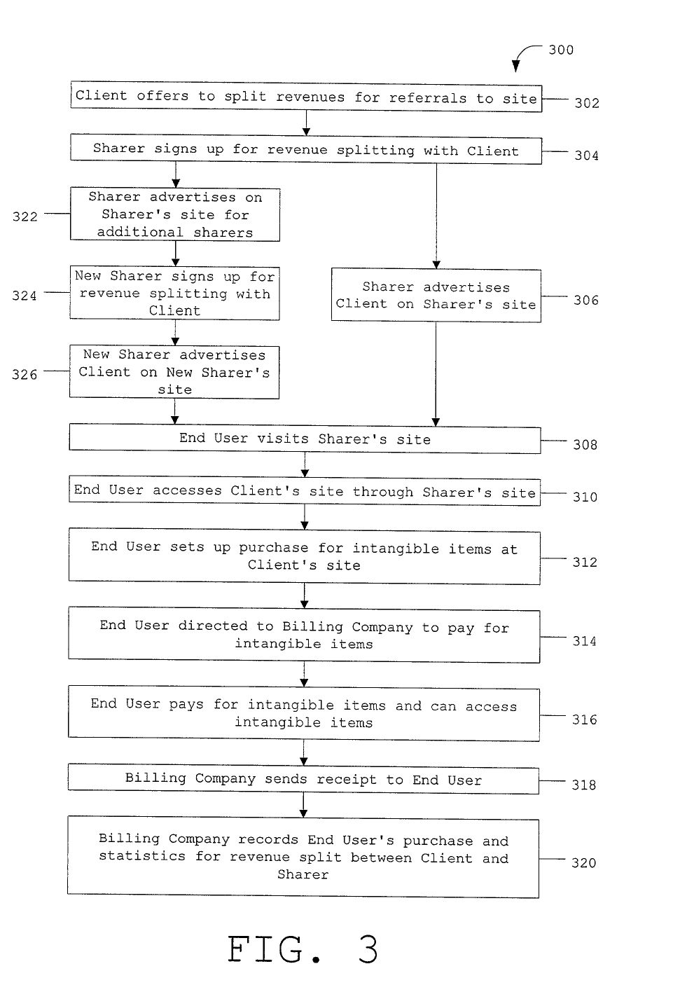

In one example of a percentage split for online sales of intangible goods shown in FIG. 2A, in a subscription service, a revenue sharer 200 receives fifty percent of net sales made by a merchant 202 to an end user upon the end user's signup with the merchant 202 and fifty percent of rebillings to the end user for continued subscription service with the merchant 202. The remaining fifty percent of signups and rebillings is divided between the merchant 202, which receives thirty-five percent of each, and a billing company 204, which receives fifteen percent of each.

In another example shown in FIG. 2B, a revenue sharer 206 receives forty-four percent of signups and forty-four percent of rebillings for a subscription service. A merchant 208 and a billing company 210 split the remaining fifty-six percent of signups and of rebillings, with the merchant 208 receiving forty-one percent of each and the billing company 210 receiving fifteen percent of each.

In another example shown in FIG. 2C, a first revenue sharer 212 receives forty-four percent of signups and forty-four percent of rebillings for a subscription service. The remaining parties, a merchant 214, a second revenue sharer 216 that recruited the first revenue sharer 212, and a billing company 218 split the remaining fifty-six percent of signups and of rebillings. The merchant 214 receives thirty-six percent of each, the second revenue sharer 216 receives five percent of each, and the billing company 218 receives the remaining fifteen percent of each.

A revenue sharer (e.g., the second revenue sharer 216), in addition to being able to refer end users to the merchant 214, can refer other revenue sharers (e.g., the first revenue sharer 212) to sign up with the merchant 214. When the first revenue sharer 212 sends an end user to the merchant 214, the second revenue sharer 216 receives a percentage of the revenue from sales to that end user (in this example, the percentage is five percent). Any revenue sharer 212, 216 can recruit additional revenue sharers to refer end users to the merchant 214, but only two revenue sharers earn a percentage of revenue from a referred sale: the revenue sharer that directly referred the end user to the merchant 214 and the revenue sharer that directly referred that revenue sharer to the merchant 214. However, additional revenue sharers may receive a percentage of revenues from such a referred sale depending on service choices of the billing company 218 and/or of the merchant 214.

The payments made to the revenue sharer 110a need not be a percentage of the merchant's net sales. Rather, the revenue sharer 110a may receive a flat fee for each unique end user that accesses the merchant's web page 106 through the revenue sharer's web page 114. In such as case, the merchant 102 may not sell any goods or service or may sell tangible and/or intangible goods and/or services; sales to the end users are not determinative of payment to the revenue sharer 110a. The merchant 102 may pay a percentage of net sales to some revenue sharers 110 while a flat fee to other revenue sharers 110. If flat fee payments to revenue sharers is an option, the interactive screens for the merchant 102 and/or the revenue sharer 110a described below may vary to account for and include this flat fee payment option.

Note that the billing company 108 may hold a reserve percentage of the end user's payment for the merchant's goods and/or services. The reserve percentage, which may be any percentage amount, is taken from the full end user payment. Thus, if the billing company 108 holds a reserve percentage, the percentage payments to the merchant 102, the revenue sharers 110a-N, and/or the billing company 108 described above are taken from the end user's payment less then reserve percentage amount of money. The billing company 108 holds the reserve percentage of money for a certain amount of time, e.g., X months or Y days, that may be constant or may vary by merchant, type of good, or other variable. After the certain amount of time expires, the billing company 108 pays the reserve percentage of money to the merchant 102, typically in conjunction with a regularly scheduled merchant payment.

The billing company 108 may hold a reserve percentage of money from a sale to cover any situation where the billing company 108 partially or fully reimburses the end user 112. An example of when such a reimbursement may be necessary is when the end user 112 pays for a subscription to the merchant's web page 106 for a certain amount of time and the web page 106 subsequently becomes unavailable because, for example, the merchant 102 goes out of business. In this example, the billing company 108 can help prevent the end user 112 from paying the merchant 102 for goods and/or services that the merchant 102 intentionally or unintentionally cannot or does not provide to the end user 112.

The merchant 102 and the revenue sharer 110a can access the billing company's web page 116 to setup and/or maintain their account(s) with the billing company 108. The merchant 102 and the revenue sharer 110a can also access the billing company's web page 116 to view reports of their shares of the sales of the merchant's intangible goods. For security reasons, the revenue sharer 110a may only view reports involving its own referrals to the merchant 102. The setup and maintenance of the accounts and the reports are described further below.

The billing company's web page 116 can include any number of individual web pages, as can the merchant's web page 106 and the revenue sharer's web page 114.

To procure the billing company's services, the merchant 102 registers with the billing company 108 through the billing company's web page 116. The merchant 102 makes and posts its own decisions when signing up with the billing company 108, such decisions including:

a) what percentage of its sales should be split with revenue sharers for signups,

b) what percentage of sales should be split with revenue sharers for recurring billings,

c) what percentage of sales should be split with revenue sharers for single purchases,

d) how much should be offered to revenue sharers in referral incentives (monetary or nonmonetary) for recruiting new revenue sharers,

e) what party or parties should provide payment to revenue sharers: the billing company, the merchant, and/or another party, and

f) how many accounts to setup with the billing company.

The merchant 102 may have multiple accounts (sub-accounts) with the billing company 108, each account associated with a different intangible item, a different sales entity, or otherwise divided per merchant choice. A different group of revenue sharers may be associated with each of the merchant's accounts.

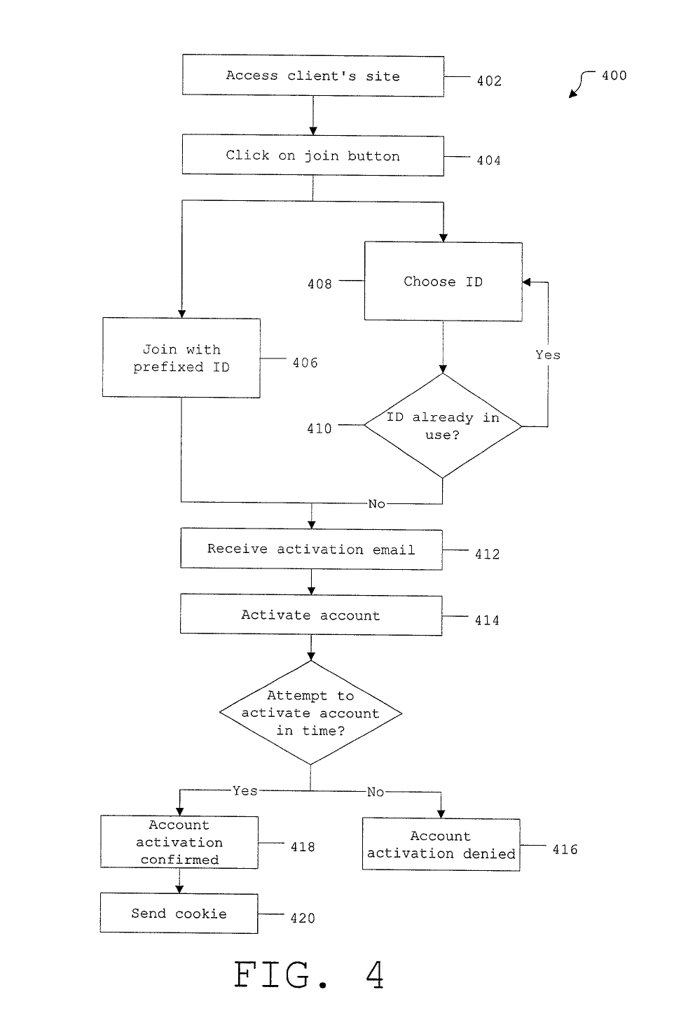

Referring to FIG. 3, the merchant 102 can share revenue with the revenue sharer 110a from sales of the merchant's intangible goods via a revenue sharing process 300. Again, the revenue sharer 110a is only used as an example; the merchant 102 can share revenue with any of the revenue sharers 110a-110N. The merchant 102 and/or the billing company 108 may, however, limit the number of revenue sharers 110a-110N that may sign up with the merchant 102 in total or per sub-account.

The merchant 102 makes 302 an offer to split revenues from sales of the intangible goods for referrals resulting in the successful purchase of the intangible goods. The offer is made on the merchant's web page 106, although the offer could be made on another web page maintained by the merchant 102 or other entity, in print, on the radio, on television, or through other similar media.

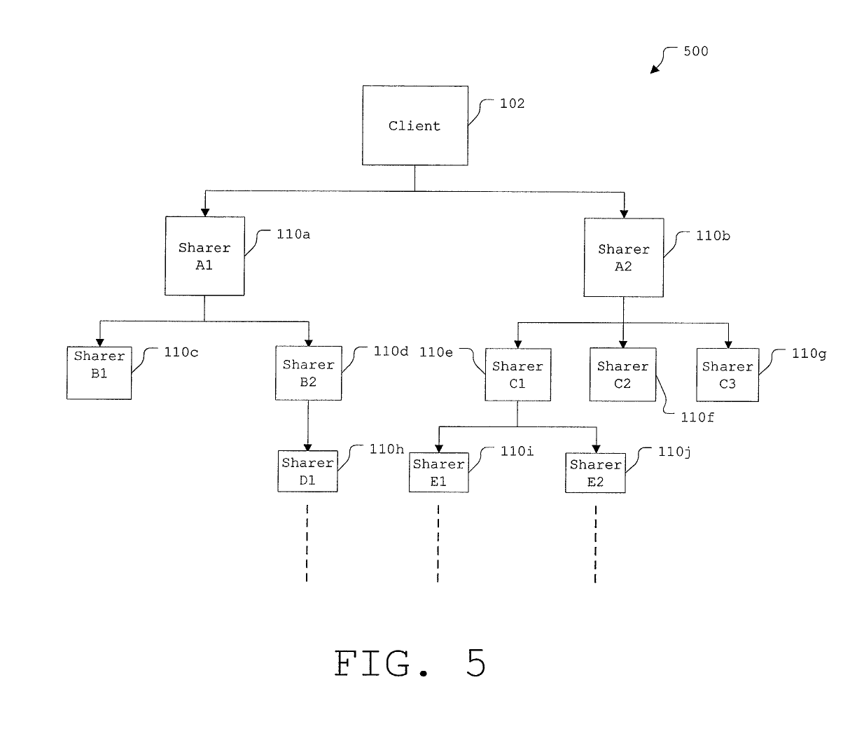

The revenue sharer 110a responds to the offer and signs up 304 to share revenues with the merchant 102. An example of how the revenue sharer 110a signs up to be a revenue sharer is shown in a registration process 400 shown in FIG. 4.

A potential revenue sharer visits 402 the merchant's web page 106 and responds to the merchant's offer of revenue sharing by clicking 404 on a join button. Clicking on the join button takes the potential revenue sharer to one of two types of signup pages provided by the billing company 108 at the billing company's web page 116. (The potential revenue sharer may instead be directed to another party's site that later transmits the appropriate information to the billing company 108.) Clicking on the join button transmits information to the billing company 108 (or to the other party), such as:

a) a request type (a hidden field indicating the information is for a revenue sharer signup),

b) the merchant's identification code,

c) a desired prefix for the potential revenue sharer's identification code,

a) a success page location (a web page location, e.g., a uniform resource locator (URL) or universal naming convention (UNC) name, that the potential revenue sharer is directed to after a successful signup via the automated setup system), and

d) a failure page location (a web page location, e.g., URL or UNC name, that the potential revenue sharer is directed to upon encountering an error in the automated setup system).

The success page and failure page locations may be part of the merchant's web page 106 or part of the billing company's web page 116. If either of the page locations is at the merchant's web page 106, the billing company 108 may provide the merchant 102 with the appropriate code and/or messages to display on the page locations.

The potential revenue sharer either joins 406 as a revenue sharer with a fixed identification code or joins 408 by choosing a personal identification code. In either case, the identification code may be a number, a name, a combination of numerical and alphanumeric characters, or other similar code. The billing company 108 may set a size range for the identification code, e.g., the identification code cannot exceed a certain number of characters. If the potential revenue sharer chooses 410 an identification code already in use, the potential revenue sharer is prompted to choose another identification code. Alternatively, the potential revenue sharer may be assigned a fixed identification code or given alternate identification code selections. Identification codes for suspended or deleted accounts may be reused.

After the potential revenue sharer is assigned or chooses an identification code, the potential revenue sharer receives 412 an activation electronic mail (email) message including an activation code. Before receiving the email message, the potential revenue sharer may receive notification on the setup page (or a page that appears after confirming the registration information entered on the setup page) that the email message is being sent to the email account entered on the setup page. The potential revenue sharer may also receive notification that it has a specified amount of time to activate its account using the activation code included in the email message.

The potential revenue sharer may also be made aware of the percentage that it will receive from the merchant's net sales generated by referrals from the potential revenue sharer in the email message or before receiving the email message. The potential revenue sharer may also be made aware of the percentage (if any) that it will receive upon recruiting another revenue sharer that succeeds in generating sales for the merchant 102. The potential revenue sharer may have to acknowledge or accept these percentages and/or additional rules, requirements, or guidelines by, for example, clicking on an accept button or checking an “agree” box before being sent the email message or as part of the activation procedure described below.

The potential revenue sharer attempts to activate 414 its account by entering the emailed activation code on the web page indicated in the email message. Alternatively, the potential revenue sharer may be able to activate its account by clicking on a web link included in the email message (or manually entering the web link in a web browser, by calling a phone number provided in the email message or on the setup page after the potential revenue sharer confirms the registration information on the setup page, or by performing another similar confirmation procedure. If the potential revenue sharer has a specified time period within which it must confirm its registration and if the potential revenue sharer does not attempt to activate its account within the specified time period, then the account activation is denied 416 and the potential revenue sharer needs to re-register with the billing company 108 as described above to become a revenue sharer 110. If the potential revenue sharer does attempt to activate its account within the specified time period, then the account activation is confirmed 418 and the potential revenue sharer is registered at the billing company 108 as a revenue sharer 110 with the merchant 102. The billing company 108 sends 420 a cookie to the revenue sharer 110 so that the billing company 108 can track and credit the revenue sharer 110 for a referral resulting in a sale of the merchant's intangible goods.

Referring back to FIG. 3, once registered with the billing company, the revenue sharer 110a advertises 306 the merchant 102 on the revenue sharer's web page 114. The advertisement can be an advertising banner, text link, or other similar advertisement. The advertisement may be specific to the intangible goods offered for sale by the merchant 102 or may more generically refer to the merchant 102. The merchant 102 is responsible for notifying the revenue sharer 110a of the proper way (if any) to setup the offer on the revenue sharer's web page 114 (e.g., size, color, location on the web page 114, etc.) as well as the code needed to execute the offer (e.g., hypertext markup language (HTML) code). The billing company 108 may, however, provide the code.

For the case where the revenue sharer 110a includes an entity providing a search engine, the revenue sharer 110a may not explicitly, persistently, or routinely advertise the merchant 102 on its web page 114. Rather, when a user (e.g., the end user 112) searches for information on a particular topic using the search engine, the end user 112 may access the merchant's web page 106 through the results of the search. In that case, the revenue sharer 110a can receive a flat fee for positioning a link to the merchant's web page 106 at a particular location within the search result, a flat fee for the end user's access of the merchant's web page 106 from the search results (whether or not the access results in a sale), or a percentage split of any sales made to the end user 112 resulting from the end user 112 accessing the merchant's web page 106 through a link in a search result. Of course, the revenue sharer 110a may also or instead provide advertising on its web page 114 for the merchant 102. Further, information regarding the particular search that the end user 112 conducted using the search engine can be transmitted to the merchant 102. The merchant 102 can use this information in tracking which searches lead to sales of its intangible goods and services. With a third party, the billing company 108, tracking the activities of the revenue sharer 110a for the merchant 102, the merchant 102 may be more confident in paying commissions to the revenue sharer 110a.

Additionally, the revenue sharer 110a may advertise 322 on its web page 114 for an unlimited number of additional revenue sharer(s) 110b-110N to sign up with the billing company 108 and to refer end users to the merchant 102 for a percentage of the merchant's revenue. The merchant 102 and/or the billing company 108 may require such advertising. This advertisement (offer) is setup as described above for the merchant's offer for revenue sharers on the merchant's web page 106. An additional revenue sharer 110b-110N signs up 324 as a revenue sharer as described above (see, for example, FIG. 4). Each additional revenue sharer 110b-110N receives its own identification code. The additional revenue sharer's identification codes may be automatically prefixed to reflect the merchant 102 or the revenue sharer 110a that recruited them, e.g., begin with the same five characters as the identification code for the revenue sharer 110a. The revenue sharer 110a earns a percentage of revenues earned by the merchant 102 from sales of its intangible goods to end users referred to the merchant 102 by a revenue sharer 110b-110N referred to the merchant 102 by the revenue sharer 110a. The new revenue sharer(s) 110b-110N may then also advertise 326 for the merchant 102 and for additional revenue sharers on their respective web pages. A revenue sharer 110 that recruits one or more other revenue sharers 110 may have access to the same capabilities as a merchant, e.g., be able to access the other revenue sharers' accounts information as discussed below with reference to various screens.

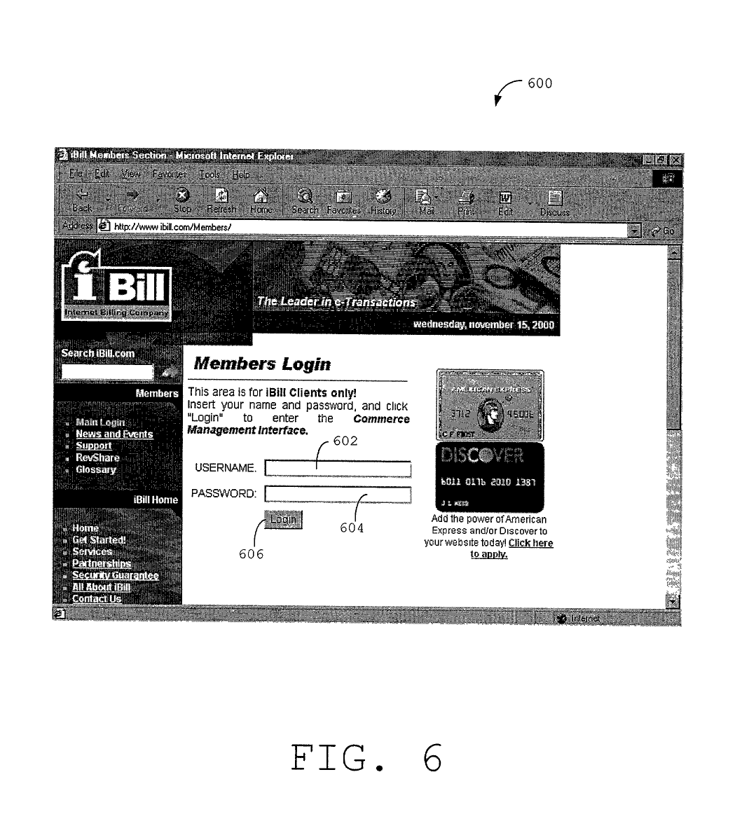

After multiple revenue sharers 110a-110N have signed up with the merchant 102, e.g., a number of revenue sharers sign up through the revenue sharer registration process 400, the merchant 102 could end up with a revenue sharing hierarchy 500 shown in FIG. 5. In this example, the merchant 102 has two first tier revenue sharers 110a and 110b that each referred second tier revenue sharers 110c-110d and 110e-110g, respectively, to the merchant 102. The direct revenue sharers 110a and 110b merely referred the second tier revenue sharers 110c-110d and 110e-110g to the merchant 102. Similarly, the second tier revenue sharers 110d and 110e referred third tier revenue sharers 110h and 110i-110j, respectively, to the merchant 102. Note that all of the revenue sharers 110a-110j (and any revenue sharers farther down in the tier structure) are technically revenue sharers with the merchant 102, not with the revenue sharers (if any) above them in the tier structure.

When the end user 112 visits 308 the revenue sharer's web page 114, the end user 112 may access 310 the merchant's web page 106 by, for example, clicking on a banner on the revenue sharer's web page 114 linked to the merchant's web page 106 via a hyperlink. When the end user 112 accesses the merchant's web page 106, the identification code for the revenue sharer 110a is transmitted to the merchant 102 (possibly along with other information) to facilitate tracking the end user's referral by the revenue sharer 110a to the merchant 102. At the merchant's web page 106, the end user 112 purchases 312 or arranges for the purchase of an intangible item, by subscription or otherwise.

To pay for the intangible item, the merchant 102 directs 314 the end user 112 to the billing company's web page 116. When the end user 112 is directed to the billing company's web page 116, information about the purchase such as the particular item purchased, price, discounts, additional fees, and other similar information is transmitted to the billing company 108. The identification codes for the revenue sharer 110a and for the merchant 102 are also transmitted to the billing company 108 to facilitate tracking the parties that will likely share revenues from any completed sales to the end user 112.

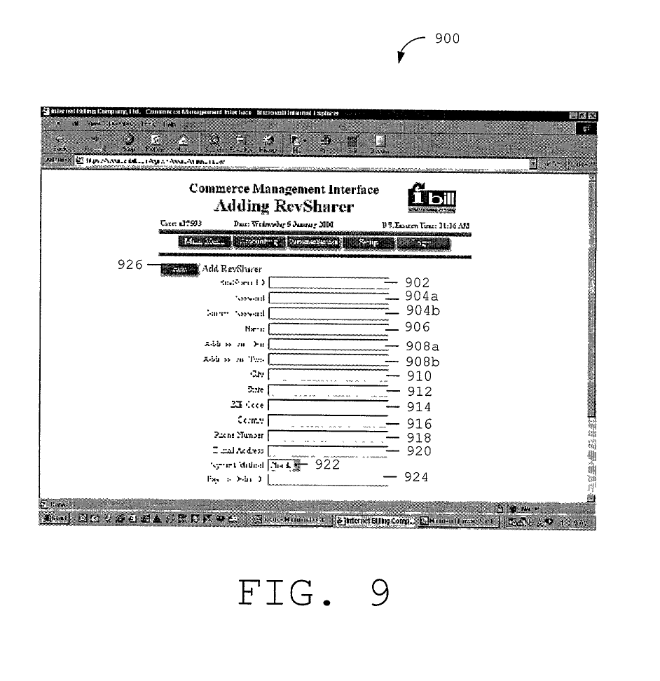

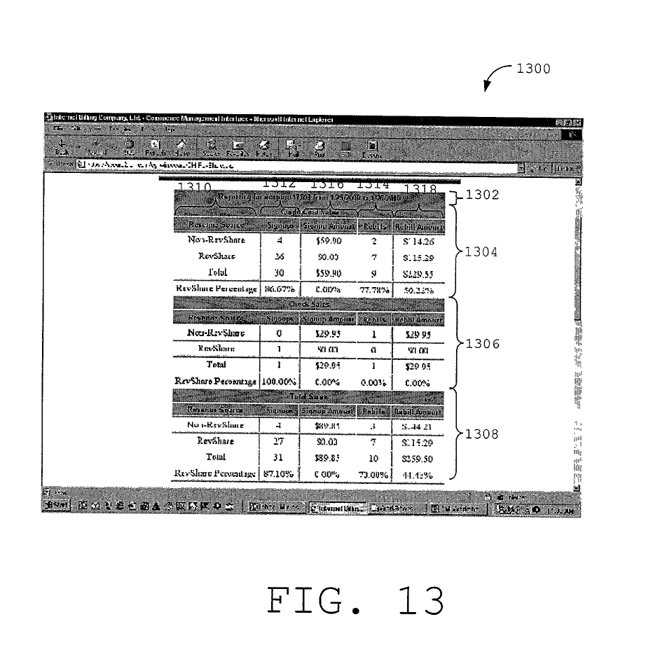

Alternatively, when the end user 112 is directed to the billing company's web page 116, the billing company 108 may send the end user 112 a cookie. The end user 112 may not be aware that it is being redirected to the billing company's web page 116, in which case the end user 112 receives the cookie and gets redirected to the merchant's web page 116 where the transaction is completed. (The cookie may instead be sent to the end user 112 by the merchant 102 or by the revenue sharer 110a when the end user 112 accesses the merchant's web page 106.) The cookie includes the relevant merchant and revenue sharer information that the billing company 108 needs to credit the proper merchant 102 and revenue sharer for purchases made by the end user 112. The cookie remains with the end user 112 for a predetermined time period, e.g., twenty-four hours, during which time the revenue sharer 110a can receive credit for any sales made by the end user 112. In this way, is the end user 112 does not complete a sale upon its first visit but later completes the transaction, the revenue sharer 110a can still receive a percentage of the sale's revenue. If the end user 112 receives such a cookie, then the merchant 102 may not be responsible for submitting information on a revenue sharer to the billing company 108, e.g., the merchant 102 need not submit some or all of the information on an add screen 800 (described below with reference to FIG. 8), the merchant 102 may not be required to enter in all or some of the default information on a defaults screen 1200 (described below with reference to FIG. 12), or the merchant 102 may not need to use an automated setup system.

The merchant 102 may use an automated setup system to collect information on a potential revenue sharer on the merchant's web page 106. The collected information can then be automatically sent to the billing company 108. In such a case, the merchant 102 can still edit the revenue sharer's information as described below.

The merchant 102 can use an automated setup system provided by the billing company 108 or use another automated setup system. In either case, fields of information that the merchant 102 may collect through its web page 106 include information similar to that described below regarding an add screen 800 (described below with reference to FIG. 8). The potential revenue sharer provides the requested information and then clicks on a join button to automatically submit the information to the billing company 108.

Information regarding the merchant 102 that may be automatically sent to the billing company 108 along with the information collected about the potential revenue sharer include:

a) a request type,

b) the merchant's identification code,

c) an identification code for the potential revenue sharer,

d) who should pay the potential revenue sharer (the merchant 102, the billing company 108, both, or a third party),

e) the identification code for an active revenue sharer of the merchant 102 that referred the potential revenue sharer to the merchant 102 (if any),

f) a success page location, and

g) a failure page location.

At the billing company's web page 116, the end user 112 pays 316 for the intangible item and thereby can gain access to the intangible item. The billing company 108 sends 318 the end user 112 a receipt for their purchase. The billing company 108 records 320 the end user's purchase and makes real-time statistics available to the merchant 102 and to the revenue sharer 110a regarding the revenue sharing for the sale.

If an error occurs and the billing company 108 cannot determine the identity of the revenue sharer that referred the end user 112 to the merchant 102, then the merchant 102 still receives its percentage of revenue from a sale to the end user 112 along with any percentage that would have gone to the revenue sharer. The billing company 108 notifies the merchant 102 that an error occurred. The merchant 102 may then decide to attempt to determine which revenue sharer(s) should receive a percentage of the sale's revenue. Examples of errors that may occur include an unidentifiable revenue sharer identification code being transmitted to the merchant 102 or to the billing company 108.

All of the merchants and revenue sharers registered with the billing company 108 may be able to access the billing company's web page 116 to obtain information about their respective accounts using a series of interactive web pages, e.g., a graphical user interface. Access to the billing company's web page 116 may be secure, i.e., the billing company 108 may provide secure access using, for example, encryption, personal identification numbers (PINs), access codes, passwords, electronic signature authentication, security keys, and/or other similar security measures. Access to parts of another entity's account by a revenue sharer or a merchant may be limited or not allowed at all.

Merchants may have access to a certain set of screens and options, while revenue sharers may have access to another set of screens and options. The set of screens and options that the merchants and the revenue sharers can access are part of a graphical user interface (GUI) and may be collectively called a commerce management interface (CMI). The GUI is always available to merchants and revenue sharers (except during service interruptions resulting from maintenance, network failure, or similar situation).

The GUI is presented as a collection of screens on the billing company's web page 116. The screens and options for the merchants and the revenue sharers may vary. For example, a merchant and its revenue sharers may have access to the same set of screens and options, each may have access to some of the same screens, or each may have access to different screens. In particular, merchants may be able to access all or part of their revenue sharers' accounts. Merchants may also be able to determine what screens and options are available to its revenue sharers.

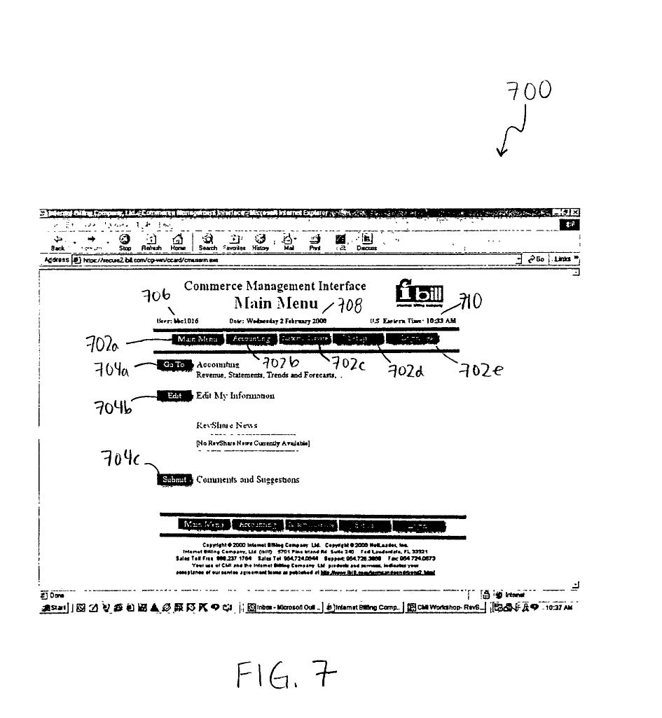

FIG. 6 shows a members login screen 600. The merchant 102 logs in to the GUI through the members login screen 600. The members login screen 600 is the introduction screen from which the merchant 102 can access its account(s), edit options, and perform other tasks as described below. The merchant 102 enters in its user name in a username dialog box 602 and its password in a password dialog box 604. By clicking on a login button 606, the merchant 102 submits this entered information to the billing company 108, which uses the entered information to determine if the merchant 102 is authorized to enter the GUI. If authorized, the billing company 108 logs in the merchant 102. If unauthorized, the billing company 108 denies login to the merchant 102, who may be allowed to attempt to login again on the members login screen 600.

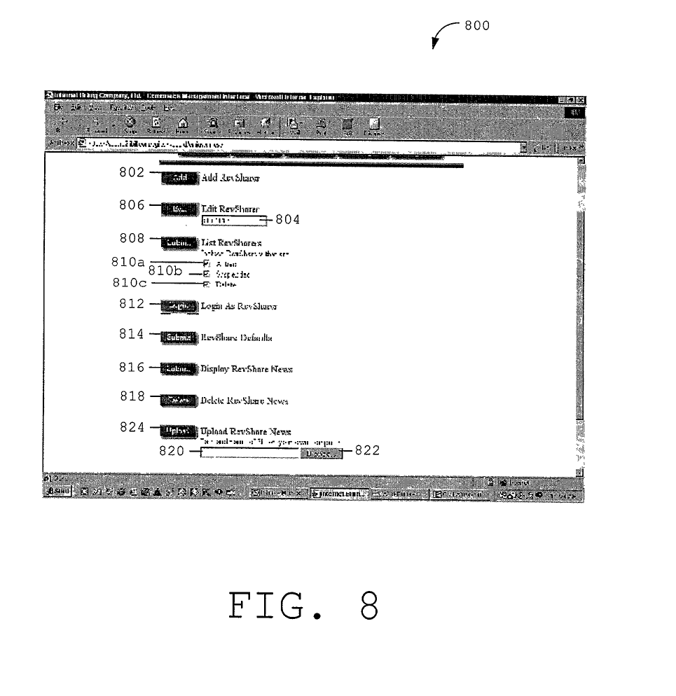

Once logged in, the merchant 102 sees a merchant menu screen 700 as shown in FIG. 7. The merchant menu screen 700 includes menu buttons 702a-702e at the top and the bottom of the merchant menu screen 700 (although the menu buttons 702a-702e could be located elsewhere on the screen 700 or in just one location). The merchant 102 can click on a menu button 702 to navigate to different screens and different options. The menu buttons 702a-702e and their functions include:

a) a main menu button 702a (displays the merchant menu screen 700),

b) an accounting button 702b (displays accounting options),

c) a customer service button 702c (displays customer service information such as frequently asked questions, contact telephone numbers and/or email addresses for the billing company 108, and other similar information),

d) a setup button 702d (displays setup options), and

e) a login button 702e (displays the members login screen 600).

The menu buttons 702a-702e are available on every screen that the merchant 102 accesses, facilitating navigation of the GUI.

The merchant menu screen 700 also includes navigation buttons 704a-704c. The navigation buttons 704a-704c and their functions include:

a) a go-to-accounting button 704a (displays accounting options),

b) an edit button 704b (displays setup options), and

c) a submit button 704c (displays ways that the merchant 102 may submit feedback to the billing company 108).

These are not the only menu buttons 702a-702e and navigation buttons 704a-704c that may be available to the merchant 102; these and/or other buttons may be available.

The merchant menu screen 700 also shows the merchant's identification code 706, a current date 708, and a current time 710.

Referring to FIG. 8, the merchant 102 controls its account and revenue sharers through a setup introduction screen 800. The merchant 102 may access the setup introduction screen 800 by logging on to the GUI and clicking on the edit button 704b (see FIG. 7).

The setup introduction screen 800 displays buttons and windows that allow the merchant 102 to edit options via a user interface. Through the setup introduction screen 800, the merchant 102 has the option to:

a) add a revenue sharer by clicking on an add button 802,

b) edit the profile of the revenue sharer entered in a name box 804 by clicking on an edit button 806,

c) list revenue sharers by clicking on a list button 808, including active revenue sharers (check box 810a), suspended revenue sharers (check box 810b), and/or deleted revenue sharers (check box 810c),

d) log in as a revenue sharer by clicking on a login button 812,

e) enter default revenue splitting settings by clicking on a submit defaults button 814,

f) display news by clicking on a display news button 816,

g) delete news by clicking on a delete news button 818, and

h) upload news from a file located at a path entered in a path box 820 (or selected by clicking on a browse button 822 and browsing for a file) by clicking on an upload news button 824.

Each of these merchant setup options is described further below.

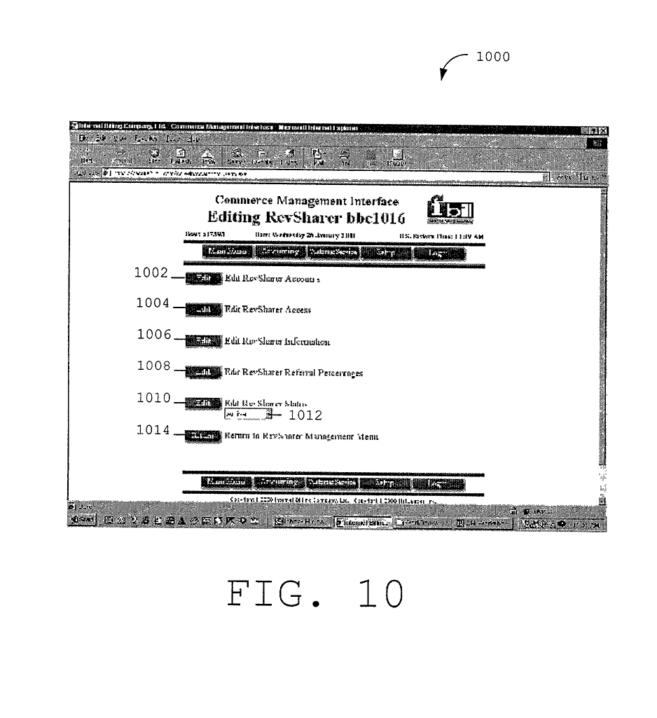

By clicking on the add button 802, the merchant 102 can access an add screen 900 as shown in FIG. 9. The add screen 900 is an interface by which the merchant 102 can add a revenue sharer. The add screen 900 shows fields 902-924 that the merchant 102 fills in to manually add a revenue sharer, including fields for the revenue sharer's:

a) identification code 902,

b) password 904a (and password confirmation 904b),

c) name 906,

d) address 908a-908b,

e) city 910,

f) state 912,

g) zip code 914,

h) country 916,

i) phone number 918,

j) email address 920,

k) payment method 922 (how the revenue sharer will receive its percentage share of appropriate sales, e.g., check, credit card, electronic funds transfer, direct bank account deposit, in-person pickup, or other similar method), and

l) specific payment method details 924 (e.g., who to write a check to, credit card information, bank account information, people authorized for in-person pickup, and other similar details as appropriate).

The add screen 900 is not limited to these fields 902-924; the add screen 900 can include these and/or other fields such as a field for a home web page, a field for a sub-account, or fields to accommodate foreign addresses. After the merchant 102 fills in the fields 902-924, the merchant 102 clicks on an add button 926 to submit the information to the billing company 108.

Some or all of the fields 902-924 may be required. If the merchant 102 fails to submit required information, the merchant 102 may be prompted to enter the missing required information or the billing company 108 may assign default data to the missing information. For example, if the merchant 102 does not assign a sub-account for the revenue sharer, the default is set to refer to all sub-accounts.

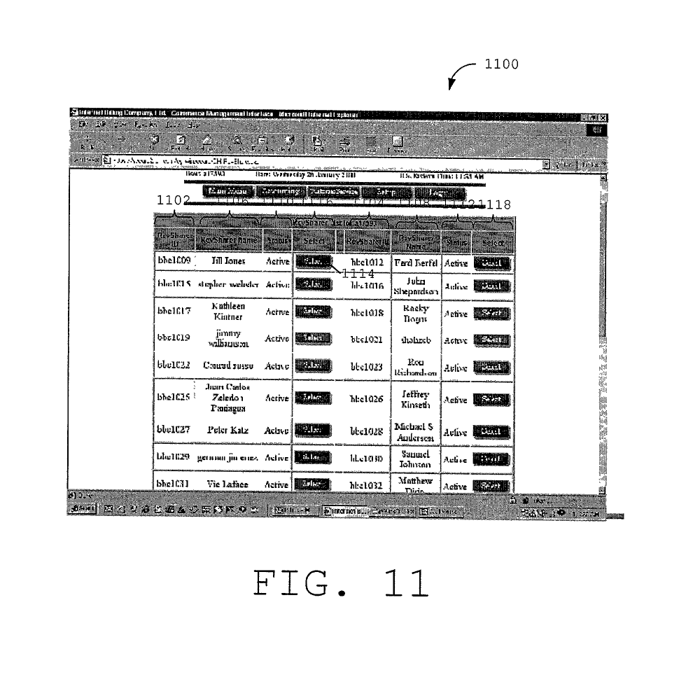

By clicking on the edit button 806 (see FIG. 8), the merchant 102 can edit information about the revenue sharer identified in the name box 804 on an edit screen 1000 as shown in FIG. 10. The edit screen 1000 shows options for the merchant 102 regarding its revenue sharers; these options are not the only edit options that may be available to the merchant 102. The merchant 102 can choose to edit:

a) revenue sharer accounts (account button 1002),

b) access that its revenue sharers have to various aspects of the GUI, such as certain accounting reports or certain news items (access button 1004)

c) revenue sharer information, such as the contact information in the fields 902-924 (see FIG. 9) (information button 1006),

d) revenue sharer referral percentages (referral button 1008), and

e) revenue sharer status (button 1010), viewing revenue sharers of a certain status as selected in a status box 1012 (e.g., active, suspended, and deleted), with the ability to change the status of a revenue sharer.

Any edits that the merchant 102 makes to a revenue sharer's account may be automatically reported to the revenue sharer 110a by the billing company 108, or the merchant 102 may be responsible for notifying the revenue sharer 110a of any alterations to its account by the merchant 102.

The merchant 102 can click on a return button 1014 to return to the screen the edit screen 1000 was accessed from or to the most recently accessed menu screen. (A similar return button may be available on any of the GUI screens.)

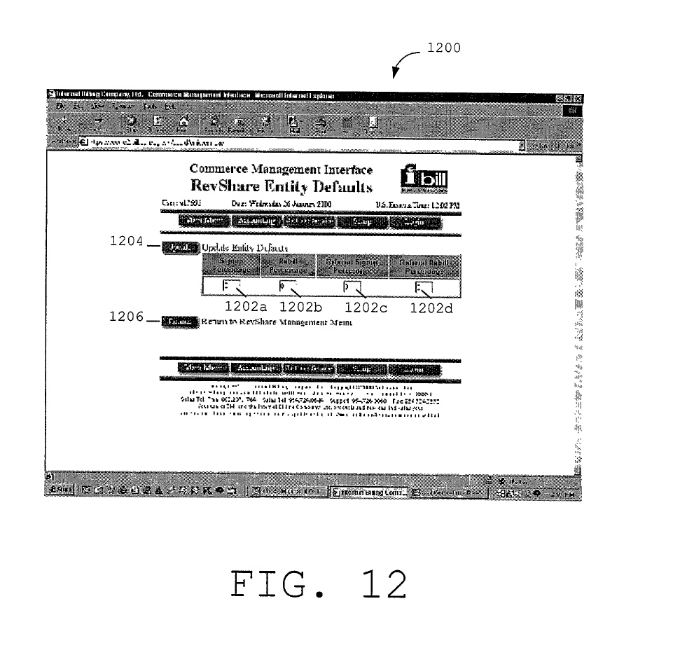

By clicking on the list button 808 (see FIG. 8), the merchant 102 can access a list screen 1100 as shown in FIG. 11. The list screen 1100 lists in table format all of the merchant's revenue sharers and information related to each of the revenue sharers. Information on the list screen for each revenue sharer includes a revenue sharer identification code (columns 1102 and 1104), a revenue sharer name (columns 1106 and 1108), and a status (columns 1110 and 1112), although more or less information may be available per merchant and/or billing company service choices. The revenue sharers on the list screen 1100 are displayed and sorted by status as selected in the check boxes 810a-810c (see FIG. 8), although the check boxes 810a-810c need not be used and the revenue sharers could be randomly listed or sorted in another way, e.g., by identification code. The merchant 102 can click on a select button 1114 (columns 1116 and 1118) for a particular revenue sharer to obtain a detailed report of the activities of that particular revenue sharer.

By clicking on the login button 812 (see FIG. 8), the merchant 102 can login as a revenue sharer, as the merchant 102 can be a revenue sharer with any number of other merchants. Logged in as a revenue sharer, the merchant 102 has access to the appropriate revenue sharing screens described below.

By clicking on the submit defaults button 814, the merchant 102 can access a defaults screen 1200 as shown in FIG. 12. On the defaults screen 1200, the merchant 102 can set defaults with respect to its revenue sharers. For example, the merchant 102 can use the defaults screen 1200 to designate the revenue percentage it will defer to its revenue sharers for:

a) one-time signups (first entry box 1202a),

b) re-bills/recurring charges (second entry box 1202b),

c) referrals for one-time signups (third entry box 1202c), and

d) referrals for re-bills/recurring charges (fourth entry box 1202d)

The entered defaults may apply to one or all of the merchant's sub-accounts.

Default percentages may populate the entry boxes 1202a-1202d that the merchant 102 may or may not be able to change. If the merchant 102 can change the default percentages or is not presented with default percentages, the merchant 102 can enter any percentage, choose from a drop-down list of percentages, and/or enter a percentage within a specified range. Once entered, the merchant 102 submits the default percentages by clicking on a submit defaults button 1204. The merchant 102 can click on a return button 1206 to return to the screen the defaults screen 1200 was accessed from or to the most recently accessed menu screen.

By clicking on the display news button 816 (see FIG. 8), the merchant 102 can display news items. The news items may include:

a) news particular to the merchant 102, such as information currently accessible by some or all of the merchant's revenue sharers and account information from the billing company 108,

b) news particular to merchants, such as information from the billing company 108 regarding, for example, new default one-time signup percentages,

c) news provided by the billing company 108 to all merchants and revenue sharers such as changes in the billing company's privacy policy, and/or

d) other news.

By clicking on the delete news button 818 (see FIG. 8), the merchant 102 can delete news items. The merchant 102 may make news items available to its revenue sharers and eventually decide to make them unavailable for viewing. By deleting a news item, the audience for that news item can no longer view that news item.

By clicking on the upload news button 824 (see FIG. 8), the merchant 102 can upload news items from a particular file location (entered in the path box 820). These uploaded news items can then be made available for display to the appropriate ones of the merchant's revenue sharers.

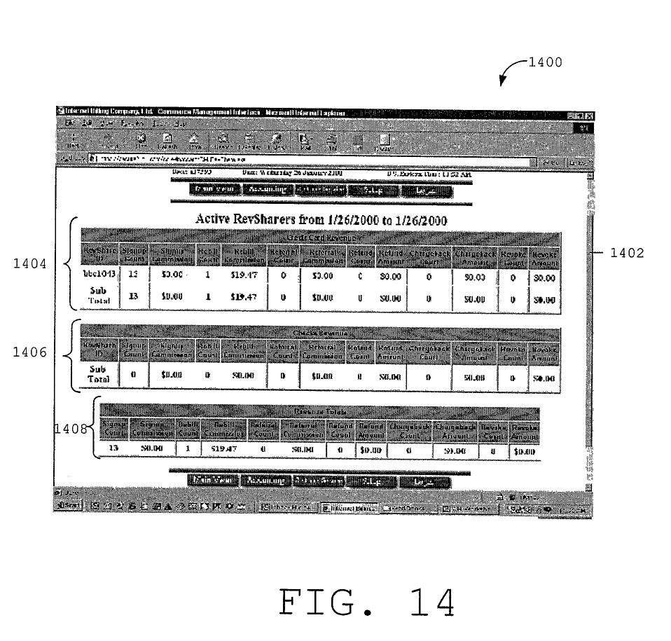

The merchant 102 can click on the go-to-accounting button 704a or the accounting button 702b (see FIG. 7) and access a reporting screen 1300 as shown in FIG. 13. The reporting screen 1300 displays accounting information for the merchant's account (or for one or more of the merchant's sub-accounts if the merchant 102 has multiple accounts). An identification bar 1302 identifies the reported account by identification code and the time frame for the reported account information.

The time frame could be daily (as shown), weekly, bi-weekly, monthly, etc.

The reporting screen 1300 provides account sales information for credit card sales in a first sales table 1304, for online check purchases in a second sales table 1306, and for total sales in a totals table 1308. The reporting screen 1300 may include more or fewer tables based on merchant and/or billing company preferences, e.g., tables for other payment methods. Each of the tables 1304, 1306, and 1308 compares signups, chargebacks, and refunds for revenue sharer generated revenue versus non-revenue sharer generated revenue and provides a percentage breakdown for sales resulting from different types of purchases.

The first sales table 1304 includes a list of revenue sources in a revenue source column 1310. The number of signup sales and the number of rebill sales for each of the revenue sources are listed in a signups column 1312 and a rebills column 1314, respectively. The monetary amount of the signup sales and the rebill sales are also listed for each of the revenue sources in a signup amount column 1316 and a rebill amount column 1318, respectively. The listed revenue sources include revenue sharers (for sales resulting from referral of end users by revenue sharers), non-revenue sharer sources (for direct sales and sales resulting from referral of end users by non-revenue sharers), a total (for all sales: revenue sharers plus non-revenue sharers), and a percentage of sales resulting from revenue sharer referrals.

The second sales table 1306 and the totals table 1308 are configured and include information similar to the first sales table 1306.

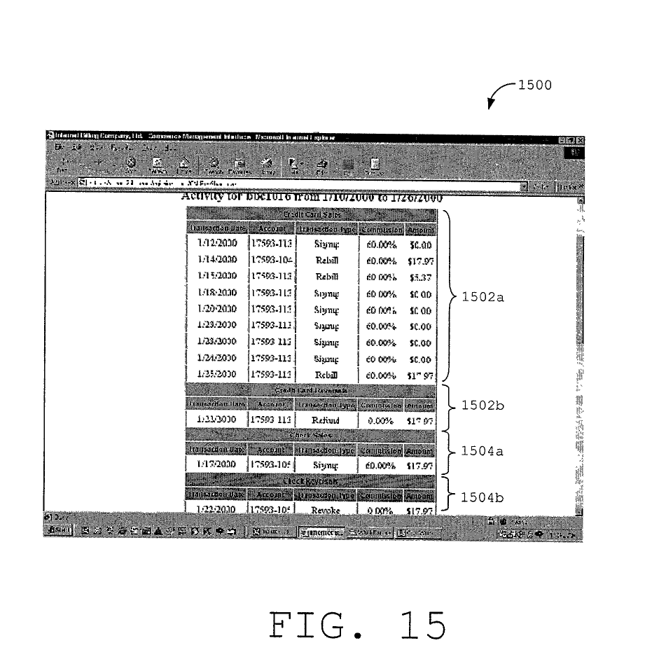

The merchant 102 can access another accounting screen, a detail report screen 1400 as shown in FIG. 14, by clicking on the go-to-accounting button 704a or the accounting button 702b (see FIG. 7). The detail report screen 1400 shows sales activity broken down by revenue sharer, detailing revenue by revenue sharer status. Only active revenue sharers are visible on the detail report screen 1400 as shown in FIG. 14. Reports for other statuses may be accessed by scrolling down the detail report screen 1400 with a vertical scroll bar 1402.

For each revenue sharer status, the detail report screen 1400 includes tables for the same categories as the reporting screen 1300 (although the detail report screen 1400 could include more or fewer tables). Each active revenue sharer table 1404 (credit card revenue), 1406 (check revenue), and 1408 (total revenue) shows the money amount and number of signups, rebills, refunds, chargebacks, and revokes for that category of sales for particular revenue sharers, identified in the tables 1404, 1406, and 1408 by identification code. If no sales exist in a particular category, then the corresponding table may still appear on the detail report screen 1400 but be blank, as in this example for the check revenue table 1406. The time frame for the detail report screen 1400 could be daily (as shown), weekly, bi-weekly, monthly, etc.

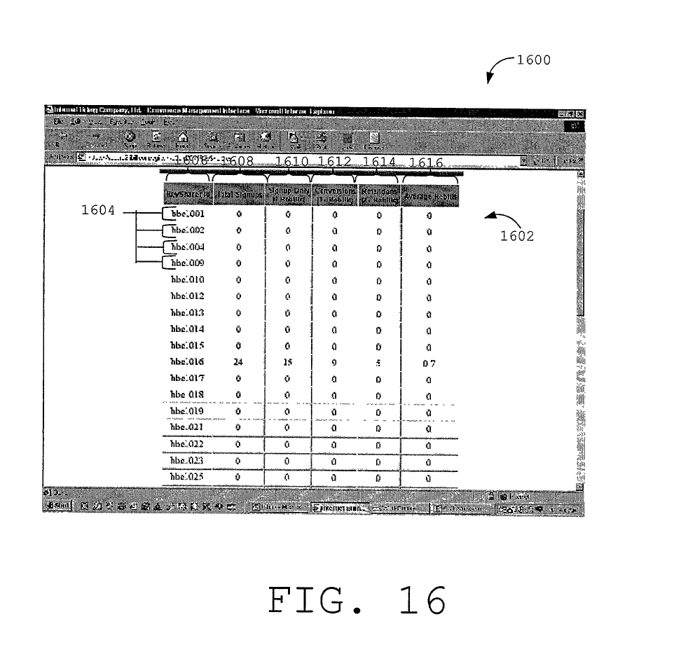

The merchant 102 can access another accounting screen, a revenue sharer transaction screen 1500 as shown in FIG. 15, by clicking on the go-to-accounting button 704a, on the accounting button 702b (see FIG. 7), on a revenue sharer identification code such as on the detail report screen 1400 (see FIG. 14), or on the select button 1114 (see FIG. 11). The revenue sharer transaction screen 1500 shows transaction details for a particular revenue sharer in tables 1502a, 1502b, 1504b, and 1504b broken down by payment type (credit card, check, etc.) and within payment type by sales and reversals. Reversals refer to chargebacks, refunds, revoked sales, and similar transactions. Each row in each of the tables 1502a-1502b and 1504a-1504b is for a particular transaction and include fields for the transaction date, the merchant account, the transaction type (e.g., signup or rebill), the designated commission split for the revenue sharer, and the earned net amount that remains to be paid to the revenue sharer for that commission split. The revenue sharer transaction screen 1500 may also include a similar table(s) for total transactions for a revenue sharer.

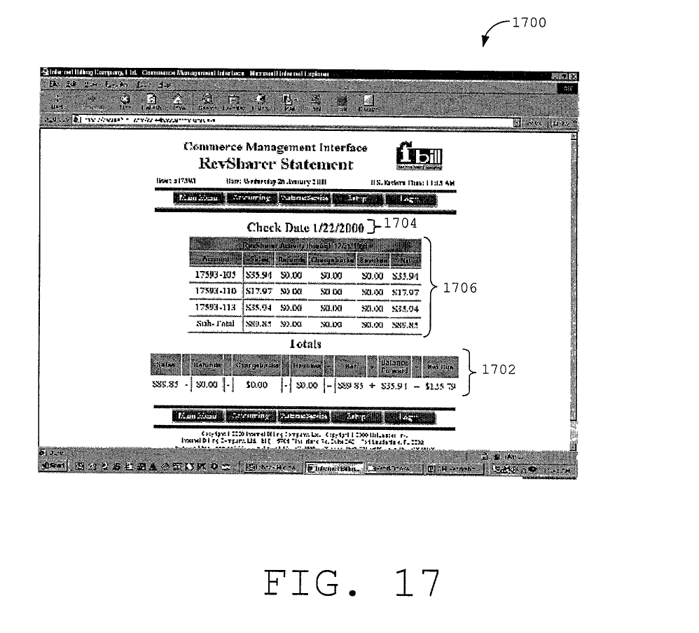

The merchant 102 can access another accounting screen, a conversion and retention screen 1600 as shown in FIG. 16, by clicking on the go-to-accounting button 704a or the accounting button 702b (see FIG. 7). The conversion and retention screen 1600 includes a conversion and retention table 1602 that lists all of the merchant's revenue sharers and shows how effective the revenue sharers have been in keeping subscribers for the merchant 102 for successive periods. Each row 1604 of the conversion and retention table 1602 includes information for a particular revenue sharer, identified by identification code in an identification column 1606. Information is provided for each revenue sharer in these columns: total signups 1608, signups only (no rebills) 1610, conversions (one or more signups leading to rebills) 1612, retentions (two or more signups leading to rebills) 1614, and average rebills 1616.

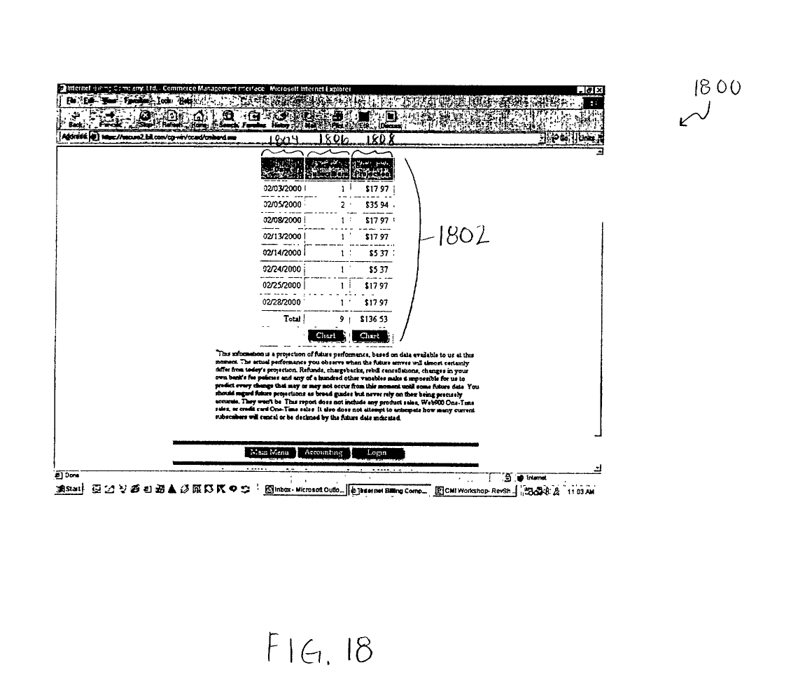

The merchant 102 can access another accounting screen, a revenue sharer statement screen 1700 as shown in FIG. 17, by clicking on the go-to-accounting button 704a or the accounting button 702b (see FIG. 7). The merchant 102 may also be able to access the revenue sharer statement screen 1700 by clicking on and/or entering a date and a revenue sharer's identification code, name or other identifier onto another screen.

The revenue sharer statement screen 1700 presents what a particular revenue sharer has earned as a result of its percentage of the merchant's net sales in a totals table 1702 and a revenue sharer activity table 1706. The billing company 108 can credit the revenue sharer 110a for a sale to the end user 112 up to twenty-four hours after the sale, so the most recent sales may not be accounted for on the revenue sharer statement screen 1700 (or on other screens where sales timing may be an issue). The revenue sharer statement screen 1700 shows the net amount due to be paid to a revenue sharer by the merchant 102 in a totals table 1702. The totals table 1702 refers to a particular billing time 1704. The totals table 1702 indicates the net amount due as a sub-total amount of sales resulting from revenue sharer referrals for each of the merchant's sub-accounts less any refunds, chargebacks, and revokes and plus any outstanding balance from a previous billing time. The sub-total amount of sales in the totals table 1702 is broken down in a revenue sharer activity table 1706. In the revenue sharer activity table 1706, the sub-total amount due is broken down into the merchant's sub-accounts and shows the net sales resulting from revenue sharer referrals for each of the merchant's sub-accounts.

If a revenue sharer can access the revenue sharer statement screen 1700, the revenue sharer may only access the revenue sharer statement screen 1700 for its account(s) only.

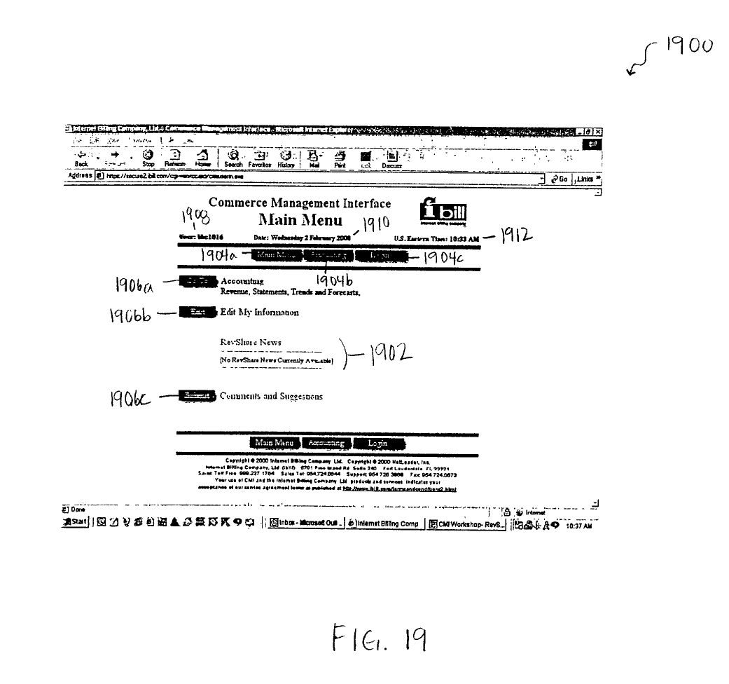

The merchant 102 can access another accounting screen, a projected earnings screen 1800 as shown in FIG. 18, by clicking on the go-to-accounting button 704a or the accounting button 702b (see FIG. 7). The projected earnings screen 1800 includes a projected earnings report 1802 that enables the merchant 102 to project earnings based upon recurring billings that are scheduled to be rebilled. The projected earnings report 1802 indicates scheduled rebill dates (in a date column 1804), the number of subscribers to be rebilled (in an active subscribers column 1806), and the best case dollar amount projection to be earned on each date (in a projection column 1808). A revenue sharer may also view the information in the projected earnings report 1802.

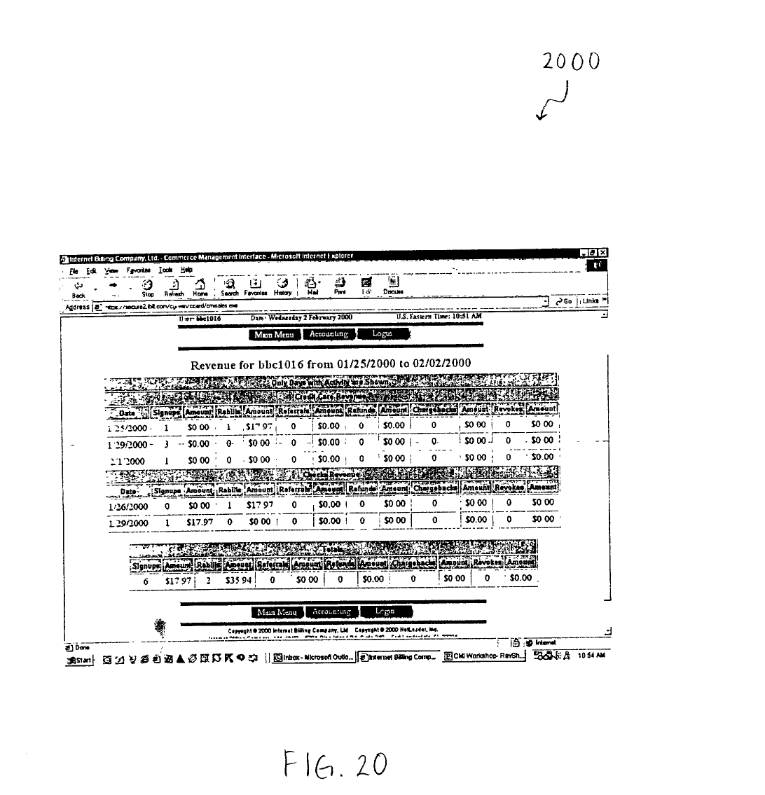

Some screens of the GUI are directed specifically to revenue sharers. For example, FIG. 19 shows a revenue sharer menu screen 1900 presenting a main menu for revenue sharers. Once logged on as a revenue sharer, the revenue sharer 110a arrives at the revenue sharer menu screen 1900. (Again, the revenue sharer 110a is used only as an example.)

The revenue sharer menu screen 1900 displays news and information for the revenue sharer 110a specifically or as a member of a particular group from the merchant 102 and/or the billing company 108 in a news section 1902. If no news exists, a message so appears in the news section 1902.

The revenue sharer menu screen 1900 also includes menu buttons 1904a-1904c at the top and/or bottom of the revenue sharer menu screen 1900 that can be used to navigate to different screens and different options available to the revenue sharer 110a. The menu buttons 1904a, 1904b, and 1904c function similarly to the merchant menu buttons 702a, 704b, and 704e, respectively (see FIG. 7).

The revenue sharer menu screen 1900 also provides the revenue sharer 110a with access to the revenue sharer's own statistics via navigation buttons 1906a-1906c. The revenue sharer 110a can click on a navigation button 1906 to access another screen that enables the revenue sharer to determine how effective it has been in sending referrals to the merchant 102 that have succeeded in becoming good sales. The navigation buttons 1906a, 1906b, and 1906c function similarly to the merchant navigation buttons 704a, 704b, and 704c, respectively (see FIG. 7).

The revenue sharer menu screen 1900 also shows the revenue sharer's identification code 1908, a current date 1910, and a current time 1912.

The merchant 102 may control what menu buttons 1904a-1904c and what navigation buttons 1906a-1906c are available to the revenue sharer 110a on the revenue sharer menu screen 1900. For example, the merchant 102 may allow the revenue sharer 110a to access accounting features of the GUI (menu button 1904b and navigation button 1906a) but not to setup features (navigation button 1906b).

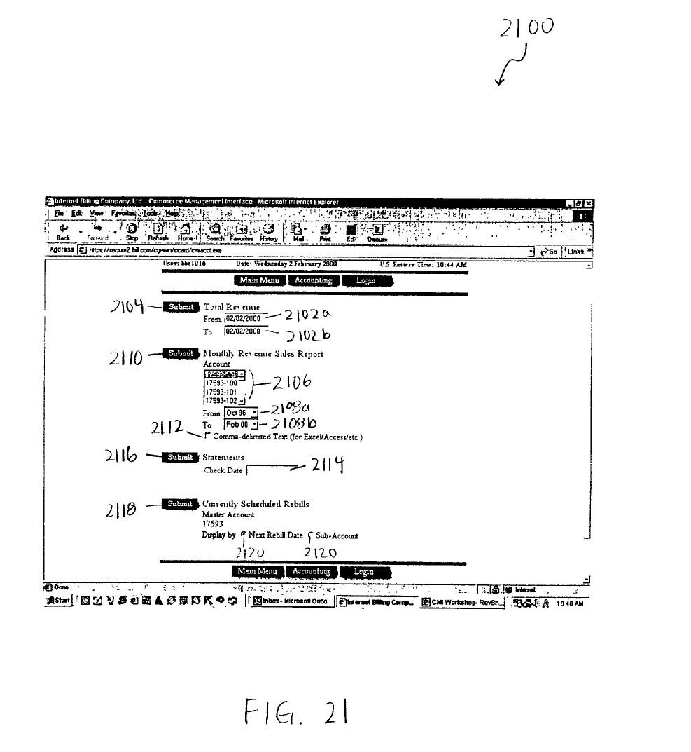

There are also accounting information screens available to revenue sharers. FIG. 20 shows a revenue sharer report screen 2000 that displays the results of the revenue sharer's own referrals to a merchant(s). The revenue sharer 110a can access the revenue sharer report screen 2000 by clicking on the go-to-accounting button 1906a or on the accounting button 1904b (see FIG. 19). The revenue sharer report screen 2000 is similar to the detail report screen 1400 (see FIG. 14) but is tailored for the particular revenue sharer 110a.

The revenue sharer 110a can access another accounting screen, a statistics screen 2100 as shown in FIG. 21, by clicking on the go-to-accounting button 1906a or on the accounting button 1904b (see FIG. 19). Through the statistics screen 2100, the revenue sharer 110a can obtain and display its own statistics, broken down by sub-accounts associated with different web pages.

The revenue sharer 110a can access its total revenue (or a screen detailing its total revenue) from a start date entered in a first date box 2102a to an end date entered in a second date box 2102b and clicking on a first submit button 2104. An example of a total revenue screen that the revenue sharer 110a may access by clicking on the first submit button 2104 is the revenue sharer transaction screen 1500 (see FIG. 15).

The revenue sharer 110a can access a monthly revenue sales report (or a screen detailing its monthly revenue sales) for an account selected in an account box 2106 from a start month entered in a first month box 2108a to an end month entered in a second month box 2108b and clicking on a second submit button 2110. The revenue sharer 110a may select a check box 2112 to comma-delimit the monthly revenue sales report to format it for display using particular applications.

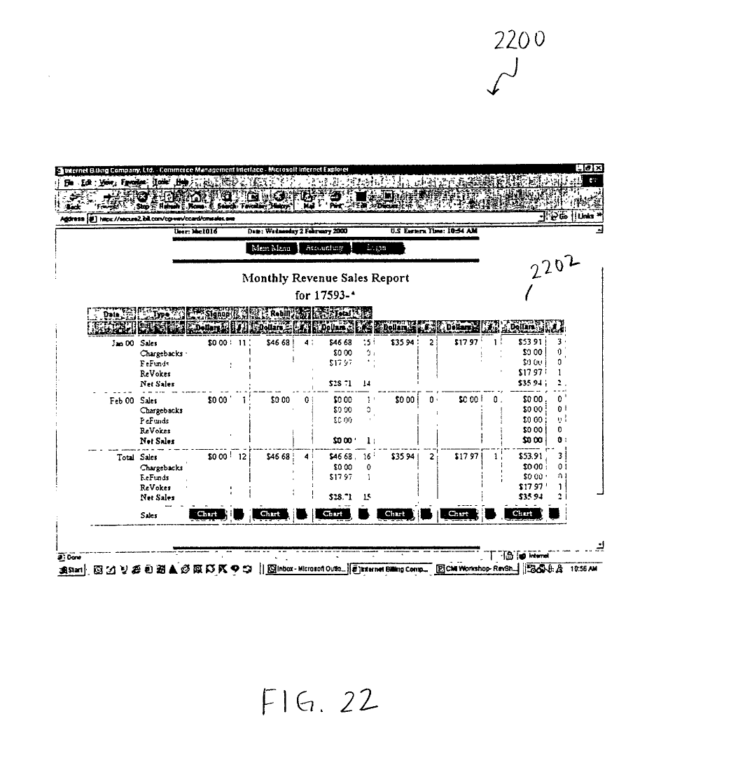

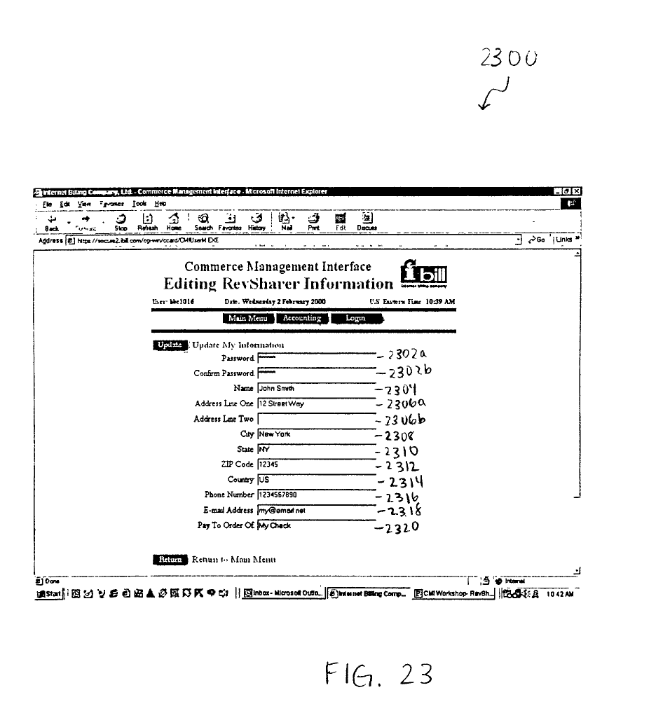

FIG. 22 shows a revenue sharer screen 2200 displaying an example monthly revenue sharer sales report 2202 that the revenue sharer may access by clicking on the second submit button 2110. The monthly revenue sharer sales report 2202 breaks down by month the total numbers and dollar amounts for signups and rebills. The monthly revenue sharer sales report 2202 further provides details regarding chargebacks, refunds, and revokes that have occurred and displays a net sales amount for each month.

Referring back to FIG. 21, the revenue sharer 110a may also access a statements report (or a statements screen) for a particular statement period for a payment date (e.g., date of a particular payment check) entered in a date box 2114 and clicking on a third submit button 2116. An example of a statements screen that the revenue sharer 110a may access by clicking on the third submit button 2116 is the revenue sharer statement screen 1700 (see FIG. 17).

The revenue sharer 110a may also display currently scheduled rebills by clicking on a fourth submit button 2118. The currently scheduled rebills can be sorted by next rebill date or by sub-account, as selected in checkboxes 2120 by the revenue sharer 110a. An example of a scheduled rebills screen that the revenue sharer 110a can access by clicking on the fourth submit button 2118 is the projected earnings screen 1800 (see FIG. 18).

Referring to FIG. 23, the revenue sharer 110a can edit its information using a revenue sharer editing screen 2300. The revenue sharer editing screen 2300 may be accessed from the revenue sharer menu screen 1900 by clicking on the edit 1906b (see FIG. 19). The revenue sharer editing screen 2300 enables the revenue sharer 110a to input and edit information about itself to the GUI for accounting and display purposes generally. Information fields 2302-2320 that the revenue sharer 110a fills in include fields similar to the fields 904-920 and 924, respectively, on the add screen 900 (see FIG. 9).

The screens discussed with reference to FIGS. 6-23 are examples and are not limited to any particular layout or configuration. For example, manipulation tools such as drop-down menus, tabs, buttons, selection boxes, and scrollbars can be implemented using any similar type of manipulation tool. In another example, the tables can be presented with any layout. Furthermore, two or more screens can be combined and presented on a single screen or screens can be divided into additional screens.

Furthermore, the screens may include more or less information and provide merchants and revenue sharers with substantially the same information. For example, the time of a transaction could be presented on the revenue sharer transaction screen 1500 or revenue sharer email addresses could be presented on the list screen 1100. In another example, the screens could each include a help button that enables the merchant 102 or the revenue sharer 110 to access online textual help and/or step-by-step assistance for various aspects of the GUI. In another example, the screens may exclude all references to rebills for a revenue sharer that was assigned a zero percent rebill percentage by a merchant.

Additionally, the screens may be accessible from other or additional screens than the ones described above. There may also be other navigation-type screens that the merchant 102 and/or the revenue sharers 110 encounter in navigating between different screens and options.

If the merchant 102 has multiple accounts with the billing company 108, the merchant 102 may be able to view information on the screens sorted by account or by one account at a time.

The techniques described here are not limited to any particular hardware or software configuration; they may find applicability in any computing or processing environment. The techniques may be implemented in hardware, software, or a combination of the two. Preferably, the techniques are implemented in computer programs executing on programmable computers that each include a processor, a storage medium readable by the processor (including volatile and non-volatile memory and/or storage elements), at least one input device, and one or more output devices. Program code is applied to data entered using the input device to perform the functions described and to generate output information. The output information is applied to one or more output devices.

Each program is preferably implemented in a high level procedural or object oriented programming language to communicate with a computer system. However, the programs can be implemented in assembly or machine language, if desired. In any case, the language may be a compiled or interpreted language.

Each such computer program is preferable stored on a storage medium or device, e.g., compact disc read only memory (CD-ROM), hard disk, magnetic diskette, or similar medium or device, that is readable by a general or special purpose programmable computer for configuring and operating the computer when the storage medium or device is read by the computer to perform the procedures described in this document. The system may also be considered to be implemented as a computer-readable storage medium, configured with a computer program, where the storage medium so configured causes a computer to operate in a specific and predefined manner.

Other embodiments are within the scope of the following claims.

What is claimed is:

1. A method comprising:
determining if a third party referred an online buyer of a good not requiring physical delivery to an online seller of the good not requiring physical delivery; and
apportioning revenue from sale of the good not requiring physical delivery between the online seller and, if a third party referred the online buyer to the online seller, to the third party.

2. The method of claim 1 in which the determining is performed automatically.

3. The method of claim 1 in which the apportioning is performed automatically.

4. The method of claim 1 further comprising registering the third party with the online seller as eligible to receive a portion of revenues from goods not requiring physical delivery sold by the online seller to an online buyer who navigated across a network to the online seller via the third party.

5. The method of claim 1 further comprising determining if a fourth party referred the third party to the online seller and if so, apportioning revenue from the sale of the good not requiring physical delivery between the online seller and, if the third party referred the online buyer to the online seller, to the third party and to the fourth party.

6. The method of claim 1 further comprising delivering the good not requiring physical delivery to the online buyer after confirming payment for the good not requiring physical delivery.

7. The method of claim 1 in which the revenue is apportioned between the third party and the online seller in accordance with predetermined percentages.

8. The method of claim 7 in which the revenue is also apportioned in accordance with predetermined percentages to a fourth party responsible for performing the determining and the apportioning.

9. The method of claim 1 in which the online buyer purchases the good not requiring physical delivery over the Internet.

10. The method of claim 1 in which the good not requiring physical delivery includes a subscription to a web site.

11. The method of claim 1 in which the good not requiring physical delivery includes a donation.

12. The method of claim 1 in which the good not requiring physical delivery includes an electronic file deliverable over a network that the online buyer used in purchasing the good not requiring physical delivery from the online seller.

13. The method of claim 1 further comprising providing data online regarding the sale of the good not requiring physical delivery.

14. The method of claim 13 in which access to the online data is secure.

15. The method of claim 13 in which the data includes how the revenue is apportioned between the third party and the online seller in accordance with predetermined percentages.

16. The method of claim 1 further comprising providing the online seller with resources on a network on which to sell the good not requiring physical delivery.

17. The method of claim 1 further comprising determining which of a plurality of third parties associated with the online seller is the third party that referred the online buyer to the online seller.

18. An article comprising a machine-readable medium which stores machine-executable instructions, the instructions causing a machine to:
determine if a third party referred an online buyer of a good not requiring physical delivery to an online seller of the good not requiring physical delivery; and
apportion revenue from sale of the good not requiring physical delivery between the online seller and, if a third party referred the online buyer to the online seller, to the third party.

19. The article of claim 18 in which the determining is performed automatically.

20. The article of claim 18 in which the apportioning is performed automatically.

21. The article of claim 18 further causing a machine to register the third party with the online seller as eligible to receive a portion of revenues from goods not requiring physical delivery sold by the online seller to an online buyer who navigated across a network to the online seller via the third party.

22. The article of claim 18 further causing a machine to determine if a fourth party referred the third party to the online seller and if so, apportioning revenue from the sale of the good not requiring physical delivery between the online seller, and, if the third party referred the online buyer to the online seller, to the third party and to the fourth party.

23. The article of claim 18 further causing a machine to deliver the good not requiring physical delivery to the online buyer after confirming payment for the good not requiring physical delivery.

24. The article of claim 18 in which the revenue is apportioned between the third party and the online seller in accordance with predetermined percentages.

25. The article of claim 24 in which the revenue is also apportioned in accordance with predetermined percentages to a fourth party responsible for performing the determining and the apportioning.

26. The article of claim 18 in which the online buyer purchases the good not requiring physical delivery over the Internet.

27. The article of claim 18 in which the good not requiring physical delivery includes a subscription to a web site.

28. The article of claim 18 in which the good not requiring physical delivery includes a donation.

29. The article of claim 18 in which the good not requiring physical delivery includes an electronic file deliverable over a network that the online buyer used in purchasing the good not requiring physical delivery from the online seller.

30. The article of claim 18 further causing a machine to provide data online regarding the sale of the good not requiring physical delivery.

31. The article of claim 30 in which access to the online data is secure.

32. The article of claim 30 in which the data includes how the revenue is apportioned between the third party and the online seller in accordance with predetermined percentages.

33. The article of claim 18 further causing a machine to providing the online seller with resources on a network on which to sell the good not requiring physical delivery.

34. The article of claim 18 further causing a machine to determine which of a plurality of third parties associated with the online seller is the third party that referred the online buyer to the online seller.

35. A system comprising:
a first mechanism configured to connect to a public network and to enable a buyer to purchase a good not requiring physical delivery over the public network from a seller; and
a second mechanism configured to connect to the public network, to confirm payment for the good not requiring physical delivery before the good not requiring physical delivery is delivered to the buyer, and to apportion the payment between the seller and a third party that referred the buyer to the seller via the public network.

36. The system of claim 35 in which the second mechanism automatically confirms the payment.

37. The system of claim 35 in which the second mechanism automatically apportions the payment.

38. A method comprising:
registering an online seller of a good with an entity;
registering a third party with the entity as eligible to receive a portion of revenues from sales of the good sold by the online seller to an online buyer who navigated across a network to the online seller via the third party.
automatically determining if the third party referred the online buyer of the good to the online seller of the good;
automatically apportioning revenue from sale of the good between the online seller and, if a third party referred the online buyer to the online seller, to the third party according to a predetermined payment structure;
automatically determining if a fourth party referred the third party to the online seller and if so, automatically apportioning revenue from the sale of the good between the online seller and, if the third party referred the online buyer to the online seller, to the third party and to the fourth party according to a predetermined payment structure; and
automatically providing data online regarding the sale of the good to the online seller, to the third party if the third party referred the online buyer to the online seller, and the fourth party if the fourth party referred the third party to the online seller.

39. The method of claim 38 in which the good includes a good not requiring physical delivery.
